(19) United States
(12) Patent Application Publication
(10) Pub. No.: US 2024/0042922 A1
(43) Pub. Date: Feb. 8, 2024

(54) VEHICLE-LIGHT MARKING TOOL

(71) Applicant: Nifco Inc., Yokosuka-shi, Kanagawa (JP)

(72) Inventor: Takehiro SATO, Yokosuka-shi, Kanagawa (JP)

(73) Assignee: Nifco Inc., Yokosuka-shi, Kanagawa (JP)

(21) Appl. No.: 18/268,663

(22) PCT Filed: Dec. 13, 2021
(86) PCT No.: PCT/JP2021/045887

§ 371 Date: Jun. 21, 2023

(30) Foreign Application Priority Data
Dec. 24, 2020 (JP) 2020-215841

(51) Int. Cl. B60Q 1/26; F21K 2/06; F21V 7/04; F21V 21/04; B60Q 1/50

(52) U.S. Cl. CPC B60Q 1/2669; F21K 2/06; F21V 7/04; F21V 21/04; B60Q 1/50; B60Q 1/2619

(57) ABSTRACT

A vehicle-light marking tool includes: an attachment part that is attached to a vehicle-constituting member; a first marking unit provided on a side of the attachment part opposite from an attachment side, the first marking unit containing a reflective material; and a second marking unit provided adjacent to the first marking unit and containing a light-emitting material.

### TECHNICAL FIELD

The present disclosure relates to a vehicle-light marking tool.

### BACKGROUND ART

Japanese Utility Model Registration No. 3215198 discloses a hole plug that closes a through-hole for maintenance of a vehicle door. A reflection light emitting unit that reflects light and emits light by power supply is provided at a center of a surface of the hole plug.

### SUMMARY OF INVENTION

### Technical Problem

Meanwhile, in the hole plug of Japanese Utility Model Registration No. 3215198, a part excluding the reflection light emitting unit does not reflect or emit light. In the hole plug of Patent Document 1, power is required for light emission of the reflection light emitting unit. Therefore, in the market, development of a hole plug that does not require power supply and is excellent in visibility at night is expected.

In view of the above fact, an object of the disclosure is to provide a vehicle-light marking tool that does not require power supply and has excellent visibility at night.

### Solution to Problem

A vehicle-light marking tool according to one aspect of the disclosure includes: an attachment part that is attached to a vehicle-constituting member; a first marking unit that is provided on a side of the attachment part opposite from an attachment side, the first marking unit containing a reflective material; and a second marking unit that is provided adjacent to the first marking unit and containing a light-emitting material.

A vehicle-light marking tool according to another aspect of the disclosure includes: an attachment part attached to a vehicle-constituting member; a first marking unit that is provided on a side of the attachment part opposite from an attachment side and that specularly reflects or retroreflects incident light; and a second marking unit that is provided adjacent to the first marking unit and emits light using the incident light or diffusely reflects the incident light.

A vehicle-light marking tool according to still another aspect of the disclosure includes: a base member including a closing part that is inserted into a through-hole formed in a vehicle-constituting member and closes the through-hole, a flange part that is formed integrally with the closing part and covers a peripheral part of the through-hole of the vehicle-constituting member, and a locking part that is formed integrally with the closing part and is inserted into the through-hole and locked; a first marking unit that is provided at a position corresponding to the closing part on a surface side of the base member and reflects incident light; and a second marking unit that is provided at the flange part and emits light using the incident light or reflects the incident light.

### Advantageous Effects of Invention

According to the disclosure, it is possible to provide a vehicle-light marking tool that does not require power supply and has excellent visibility at night.

### BRIEF DESCRIPTION OF DRAWINGS

FIG. 1 is a perspective view of a hole plug as a vehicle-light marking tool according to an embodiment of the disclosure as viewed obliquely from above.

FIG. 2 is a front view of the hole plug illustrated in FIG. 1.

FIG. 3 is a cross-sectional view taken along line 3-3 of the hole plug illustrated in FIG. 2.

FIG. 4 is a cross-sectional view (cross-sectional view corresponding to FIG. 3) illustrating a state in which the hole plug illustrated in FIG. 3 is inserted into a through-hole.

FIG. 5 is a view illustrating a state in which the hole plug illustrated in FIG. 1 is attached to a vehicle door.

FIG. 6 is a front view of a vehicle-light marking tool according to another embodiment of the disclosure.

FIG. 7 is a cross-sectional view taken along line 7-7 of the vehicle-light marking tool illustrated in FIG. 6.

FIG. 8 is a front view of a vehicle-light marking tool according to another embodiment of the disclosure.

FIG. 9 is a cross-sectional view taken along line 9-9 of the vehicle-light marking tool illustrated in FIG. 8.

### DESCRIPTION OF EMBODIMENTS

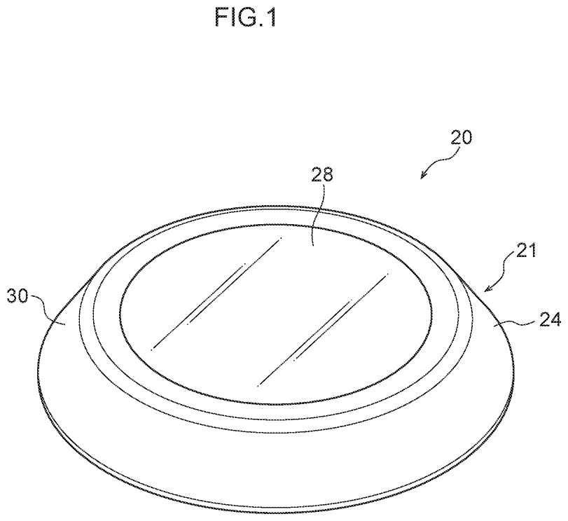

Next, a hole plug 20 as a vehicle-light marking tool according to an embodiment of the disclosure will be described with reference to FIGS. 1 to 5.

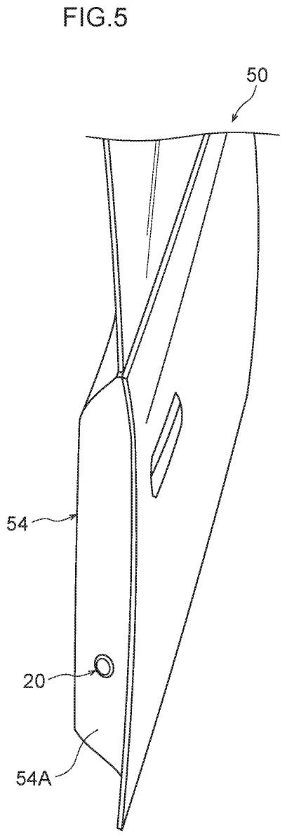

As illustrated in FIG. 5, the hole plug 20 of the present embodiment is a plug member for closing a through-hole 52 for internal work formed in a vehicle door (specifically, a side door) 50 as an example of a vehicle-constituting member. Specifically, the hole plug 20 closes the through-hole 52 formed in a vehicle rear side end part 54A of a door inner panel 54 constituting a vehicle interior side of the vehicle door 50.

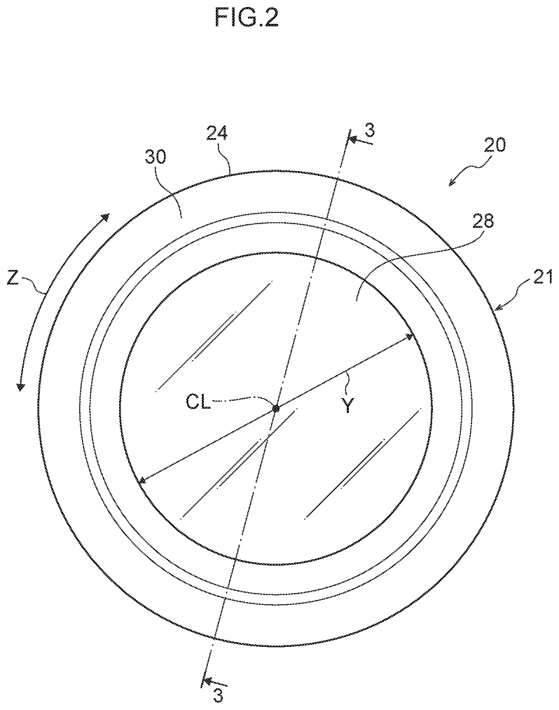

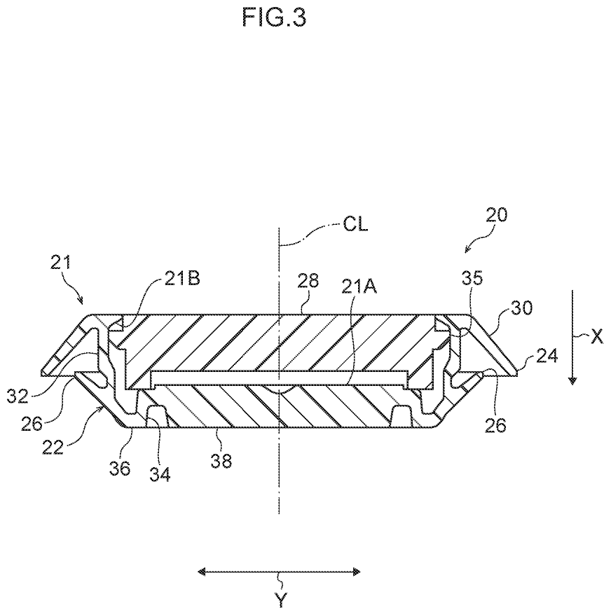

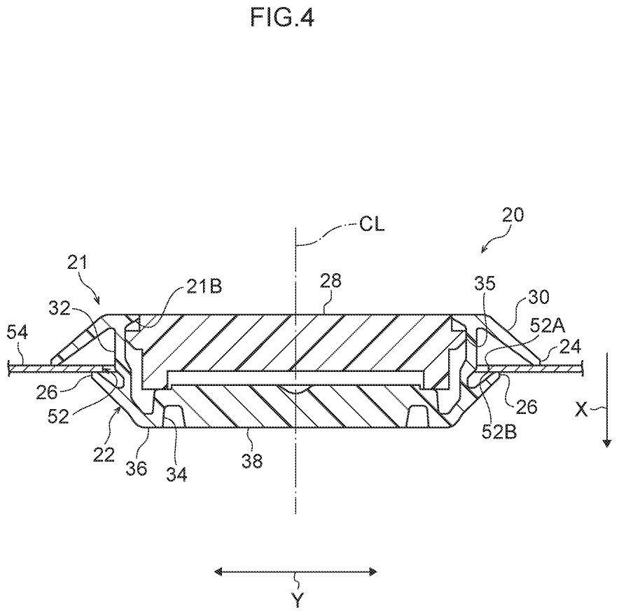

An arrow X illustrated in FIGS. 3 and 4 indicates one axial direction of the hole plug here, an insertion direction (hereinafter referred to as a “plug insertion direction” if appropriate). An arrow Y illustrated in FIGS. 2 to 4 indicates a radial direction (hereinafter referred to as a “plug radial direction” if appropriate) of the hole plug 20, and an arrow Z indicates a circumferential direction (hereinafter referred to as a “plug circumferential direction” if appropriate) of the hole plug 20. A reference sign CL illustrated in FIGS. 3 and 4 indicates a central axis of the hole plug 20. An inside in the plug radial direction refers to a side close to the central axis CL along the plug radial direction, and an outside in the plug radial direction refers to a side far from the central axis CL along the plug radial direction.

As illustrated in FIGS. 1 to 4, the hole plug 20 includes a closing part 22, a flange part 24, a claw part 26, a first marking unit 28 as a light reflecting unit, and a second marking unit as a light emitting unit.

(Closing Part 22)

As illustrated in FIGS. 3 and 4, the closing part 22 is a part that closes the through-hole 52 of the door inner panel 54 in the hole plug 20. The closing part 22 is inserted into the through-hole 52 of the door inner panel 54 to close the through-hole 52.

As illustrated in FIGS. 3 and 4, the closing part 22 includes a cylindrical outer peripheral wall part 32, a cylindrical inner peripheral wall part 34 disposed concentrically with the outer peripheral wall part 32 inside the outer peripheral wall part 32, a connecting wall part 36 connecting an end part of the outer peripheral wall part 32 on the plug insertion direction side and an end part of the inner peripheral wall part 34 on the plug insertion direction side, and a bottom part 38 bridged across an end part of the inner peripheral wall part 34 on a side opposite from the plug insertion direction to close the inside of the inner peripheral wall part 34. The “cylindrical shape” in the present embodiment includes a shape having a perfect circle or an ellipse in cross section.

(Flange Part 24)

As illustrated in FIG. 4, the flange part 24 is a part that covers the peripheral part of the through-hole 52 of the door inner panel 54 in the hole plug 20. As illustrated in FIGS. 1 and 3, the flange part 24 protrudes outward in the plug radial direction from an end part of the outer peripheral wall part 32 on a side opposite to the plug insertion direction, and has an annular shape.

As illustrated in FIG. 4, an outer diameter of the flange part 24 is larger than a hole diameter of the through-hole 52. Therefore, in a state where the closing part 22 of the hole plug 20 is inserted into the through-hole 52 of the door inner panel 54 and the claw part 26 to be described later is hooked on an edge part 52B of the through-hole 52, the through-hole 52 is closed by the closing part 22, and the peripheral part of the through-hole 52 is covered (see FIG. 4). That is, the through-hole 52 of the door inner panel 54 and the peripheral part of the through-hole 52 are blind by the hole plug 20.

(Claw Part 26)

As illustrated in FIGS. 3 and 4, the claw part 26 is a part for attaching the hole plug 20 to the vehicle door 50. Specifically, the claw part 26 is a part inserted into the through-hole 52 of the door inner panel 54 and locked to the edge part (in other words, a part forming the through-hole 52 of the door inner panel 54) 52B of the through-hole 52. The claw part 26 in the present embodiment is an example of a locking part in the disclosure.

A plurality of the claw parts 26 are formed on an outer peripheral surface of the outer peripheral wall part 32 at intervals in the plug circumferential direction. Since the claw part 26 abuts on an edge part 52A of the through-hole 52 and is elastically deformed when the closing part 22 is inserted into the through-hole 52 of the door inner panel 54, the closing part 22 can be easily inserted into the through-hole 52. In this regard, in a case in which a force in a pulling direction acts on the closing part 22, the claw part 26 is caught by the edge part 52B of the through-hole 52 (in other words, the claw part 26 is locked to the edge part 52B), so that the closing part 22 is prevented from coming off from the through-hole 52.

In the present embodiment, the closing part 22, the flange part 24, and the claw part 26 are integrally formed to constitute the base member 21. The base member 21 is an integrally molded resin product formed of an elastically deformable resin material.

The base member 21 is provided with a recess 21A at a position corresponding to the closing part 22 on the front surface side. Specifically, the recess 21A includes the inner peripheral wall part 34 and the bottom part 38 of the base member 21. The first marking unit 28 is fitted into the recess 21A. The inner peripheral wall part 34 constituting a recessed wall of the recess 21A is provided with a stopper 21B protruding radially inward.

(First Marking Unit 28)

As illustrated in FIGS. 1 to 4, the first marking unit 28 is a part that reflects light in the hole plug 20. The first marking unit 28 contains a reflective material, and specularly reflects, retroreflects, or diffusely reflects incident light. As the reflective material contained in the first marking unit 28, a retroreflective material is preferably used. In the present embodiment, the first marking unit 28 has a reflector made of a retroreflective material. Therefore, the first marking unit 28 of the present embodiment retroreflects the emitted light.

As illustrated in FIGS. 1 and 3, the first marking unit 28 has a disk-shape or a columnar shape. The first marking unit 28 is provided on the side of the base member 21 opposite to the insertion side of the closing part 22. Specifically, the first marking unit 28 is provided at a position corresponding to the closing part 22 on the front surface side of the base member 21. Specifically, the first marking unit 28 is fitted into the recess 21A of the base member 21. That is, the first marking unit 28 is attachable to and detachable from the base member 21.

A ridge part 35 extending along the circumferential direction is provided on the outer peripheral surface of the first marking unit 28. Here, in a state where the first marking unit 28 is fitted into the recess 21A, the ridge part 35 is positioned between the bottom part 38 and the stopper 21B, and the ridge part 35 and the stopper 21B abut on each other, whereby the first marking unit 28 is prevented from coming off from the base member 21. That is, the ridge part 35 and the stopper 21B maintain a state in which the first marking unit 28 is fitted into the recess 21A of the base member 21.

(Second Marking Unit 30)

As illustrated in FIGS. 1 to 4, the second marking unit 30 is a part that receives light and emits light in the hole plug 20. The second marking unit 30 contains a light-emitting material, and emits light using incident light. As the light-emitting material contained in the second marking unit 30, a fluorescent material or a phosphorescent material is preferably used. In the present exemplary embodiment, the second marking unit 30 is made of a resin material containing a fluorescent material. Therefore, the second marking unit 30 of the present embodiment emits light when receiving light.

As illustrated in FIGS. 1 and 3, the second marking unit 30 is provided adjacent to the first marking unit 28. The second marking unit 30 is annularly provided along the flange part 24. As a result, the first marking unit 28 is surrounded by the annular second marking unit 30. The “annular shape” in the present embodiment includes an annular shape having a circular outer shape, an elliptical annular shape having an elliptical outer shape, and a polygonal annular shape having a polygonal outer shape (for example, a triangle or a rectangle).

In the present embodiment, the entire flange part 24 serves as the second marking unit 30. Here, since the base member 21 of the present embodiment is formed of a resin material containing the same light-emitting material (fluorescent material in the present embodiment) as the second marking unit 30, it is easy to cause the base member 21 to include the second marking unit 30 at the time of manufacturing the base member 21. The disclosure is not limited to the above configuration. For example, a surface part of the flange part 24 may be used as the second marking unit 30.

Next, operational effects of the hole plug 20 of the present embodiment will be described.

In the hole plug 20, when the closing part 22 is inserted into the through-hole 52 while pressing the bottom part 38 of the closing part 22 via the first marking unit 28 mounted to the base member 21, the restored claw part 26 is caught by the edge part 52B of the through-hole 52, and the hole plug 20 is locked to the through-hole 52 of the door inner panel 54. When the hole plug 20 is attached to the door inner panel 54 in this manner, the through-hole 52 of the door inner panel 54 and the peripheral part thereof are blindfolded and water-stopped by the hole plug 20.

Here, since the hole plug 20 is attached to the vehicle door 50 by a simple operation of inserting the closing part 22 into the through-hole 52 of the vehicle door 50 and hooking (in other words, locking) the claw part 26 on the edge part 52B, attachment to the vehicle door 50 is facilitated.

In the hole plug 20, the first marking unit 28 containing a reflective material is provided on the side of the closing part 22 opposite from the plug insertion side. Since light (incident light) is reflected by the first marking unit 28, the hole plug 20 can be visually recognized even from a long distance at night. That is, the hole plug 20 is excellent in visibility at night, for example, as compared with one that does not include the first marking unit 28 containing a reflective material. In particular, in the present embodiment, the first marking unit 28 contains a retroreflective material, that is, the first marking unit 28 has retroreflectivity. As described above, in the hole plug 20, the light incident on the first marking unit 28 directly returns to a light source, so that the first marking unit 28 (that is, hole plug 20) can be easily visually recognized even from a long distance at night.

In the hole plug 20, the second marking unit 30 is provided adjacent to the first marking unit 28. Since the second marking unit 30 contains a light-emitting material (fluorescent material in the present embodiment), the second marking unit 30 emits light by receiving light even without power supply. In particular, in the present embodiment, since the second marking unit 30 contains a fluorescent material, a light emission intensity is high, and visibility at night is improved.

In the hole plug 20, when light is emitted, the first marking unit 28 reflects light, and the second marking unit 30 emits light. Therefore, an area of a part that receives light and shines is larger compared to one that includes only one of the first marking unit 28 and the second marking unit 30, for example. As a result, in the hole plug 20, since the area of the part that receives light and shines is increased, visibility at night is excellent.

From the above, the hole plug 20 of the present embodiment does not require power supply and has excellent visibility at night.

By attaching the hole plug 20 as described above to the vehicle door 50, an open state of the vehicle door 50 at night can be easily visually recognized from a following vehicle. The following vehicle here includes an automobile, a motorcycle, a motorized bicycle, a bicycle, and the like.

In the hole plug 20, since the second marking unit 30 is formed of a resin material containing a light-emitting material (fluorescent material in the present embodiment), the second marking unit 30 can be easily formed by resin molding (for example, a conventionally known resin molding method).

In the hole plug 20, since the annular second marking unit 30 surrounds the first marking unit 28, an outer shape of the second marking unit 30 becomes large. As a result, in the hole plug 20, for example, the area of the part that receives the emitted light and shines is larger compared to one in which the second marking unit 30 is adjacent to the first marking unit 28 without surrounding the first marking unit 28, and thus visibility at night is excellent.

In the hole plug 20, the through-hole 52 of the vehicle door 50 is closed by the closing part 22 of the base member 21, and the peripheral part of the through-hole 52 of the vehicle door 50 is covered by the flange part 24, so that an appearance around the through-hole 52 of the vehicle door 50 is improved. In the hole plug 20, the base member 21 can be attached to the vehicle door 50 by a simple operation of inserting the closing part 22 into the through-hole 52 of the vehicle door 50 and locking the claw part 26. In the hole plug 20, the first marking unit 28 is provided at a position corresponding to the closing part 22 on the surface side of the base member 21, and the flange part 24 adjacent to the first marking unit 28 is the second marking unit 30. Therefore, the area of the part that receives light and shines is increased, and the visibility at night is improved.

In the hole plug 20, the first marking unit 28 is attachable to and detachable from the base member 21. Therefore, in the hole plug 20, the first marking unit 28 can be replaced in a case in which a problem occurs in the first marking unit 28.

In the hole plug 20, the first marking unit 28 is fitted into the recess 21A of the base member 21. Therefore, in the hole plug 20, for example, as compared to one in which the first marking unit 28 is installed on the surface of the base member in which the recess 21A is not provided, a step between the first marking unit 28 and the flange part 24 (that is, second marking unit 30) can be reduced. As a result, an appearance of the hole plug 20 is improved.

### OTHER EMBODIMENTS

In the hole plug 20 of the above-described embodiment, the first marking unit 28 is a disk-shaped or columnar member fitted into the recess 21A of the base member 21, but the disclosure is not limited to this configuration. For example, the first marking unit 28 may be provided on a surface part of the disk-shaped or columnar member to be fitted into the recess 21A of the base member 21. In a case in which the first marking unit 28 is provided on the surface part of the disk-shaped or columnar member, the first marking unit 28 may be formed of a reflector, a reflective paint, a metal foil, or the like.

In the hole plug 20 of the above-described embodiment, the second marking unit 30 contains a fluorescent material, but the disclosure is not limited to this configuration. The second marking unit 30 may contain a phosphorescent material. In this case, since the second marking unit 30 contains a phosphorescent material, a light emission time becomes long according to the stored light energy, and visibility at night is improved. The other operational effects are similar to those of the hole plug 20 of the above-described embodiment. For example, the second marking unit 30 may include a part containing a fluorescent material and a part containing a phosphorescent material. In this case, the fluorescent material-containing part and the phosphorescent material-containing part may be alternately provided along the flange part 24, or the fluorescent material-containing part (or phosphorescent material-containing part) may be provided on the radially inner side of the flange part 24 and the phosphorescent material-containing part (or fluorescent material-containing part) may be provided on the radially outer side of the flange part 24. By configuring the second marking unit 30 with the fluorescent material-containing part and the phosphorescent material-containing part in this manner, it is possible to achieve a balance between the light emission intensity and the light emission time, and visibility at night is further improved.

In the hole plug 20 of the above-described embodiment, a configuration is adopted in which the first marking unit 28 has a reflector formed of a retroreflective material, but the disclosure is not limited to this configuration. For example, the first marking unit 28 may be made of a resin material containing a powdery reflective material. Examples of the powdery reflective material include metal flakes, glass flakes, and the like. As the resin material containing the powdery reflective material, a transparent resin material is preferably used.

In the hole plug 20 of the above-described embodiment, the second marking unit 30 is formed of a resin material containing a light-emitting material (fluorescent material), but the disclosure is not limited to this configuration. For example, the second marking unit 30 may be made of a resin material containing a powdery reflective material. Examples of the powdery reflective material include metal flakes, glass flakes, and the like. As the resin material containing the powdery reflective material, a transparent resin material is preferably used. A surface layer part of the flange part 24 may be the second marking unit 30, and the second marking unit 30 may be formed of a reflector (including a retroreflector), a reflective paint, a reflective film (for example, a metal foil), or the like.

In the hole plug 20 of the above-described embodiment, the second marking unit 30 is annularly formed along the flange part 24, but the disclosure is not limited to this configuration. For example, a plurality of the second marking units 30 may be formed along the flange part 24 at intervals in the plug circumferential direction.

In the hole plug 20 of the above-described embodiment, the second marking unit 30 is annularly provided along the flange part 24, that is, has the same annular shape as the flange part 24, but the disclosure is not limited to this configuration. For example, the outer shape of the second marking unit 30 may be elliptical or polygonal regardless of the shape of the flange part 24.

In the hole plug 20 of the above-described embodiment, the second marking unit 30 surrounds the first marking unit 28, but the disclosure is not limited to this configuration. The first marking unit 28 may surround the second marking unit 30. In this case, for example, the reflective material constituting the first marking unit 28 is disposed on the flange part 24, and the resin material constituting the second marking unit 30 is fitted into the recess 21A of the base member 21.

In the hole plug 20 of the above-described embodiment, the first marking unit 28 is attachable to and detachable from the base member 21, but the disclosure is not limited to this configuration. For example, the first marking unit 28 may be non-attachable to and non-detachable from the base member 21.

In the above-described embodiment, the hole plug 20 is attached to the through-hole 52 of the vehicle door (side door) 50, but the disclosure is not limited to this configuration. For example, the hole plug 20 may be attached to a through-hole formed in a back door of the vehicle. The hole plug 20 of the above-described embodiment may be attached to a sliding vehicle door (side door).

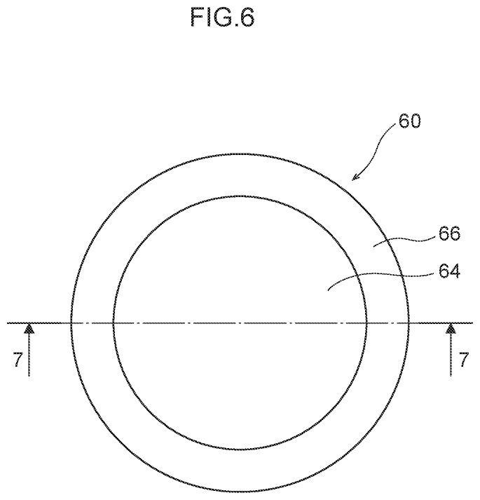

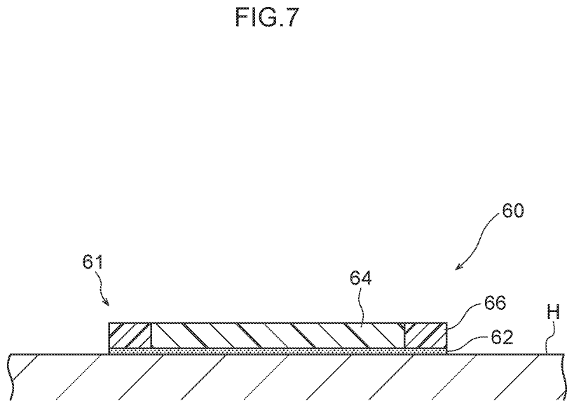

In the above-described embodiment, the first marking unit 28 and the second marking unit 30 are provided at the hole plug 20 for a vehicle, but the disclosure is not limited to this configuration. For example, the vehicle-light marking tool 60 (hereinafter referred to as a “light marking tool 60” if appropriate) may be attached to an attachment location H different from the through-hole 52 of the vehicle door 50 described above. Specifically, as illustrated in FIGS. 6 and 7, the light marking tool 60 includes a plate-shaped base member 61. The attachment part 62 is provided on one plate surface of the base member 61. The attachment part 62 is an adhesive layer and is attached to the attachment location H. A first marking unit 64 and a second marking unit 66 are provided adjacent to the other plate surface of the base member 61. The second marking unit 66 is annular and surrounds the first marking unit 64. The first marking unit 64 is made of the same material as the first marking unit 28. The second marking unit 66 is made of the same material as the second marking unit 30. The light marking tool 60 is attached to the attachment location H by attaching the attachment part 62 to the attachment location H. Since light (specifically, incident light) is reflected by the first marking unit 64, the light marking tool 60 can be visually recognized even from a long distance at night. That is, for example, the light marking tool 60 is excellent in visibility at night compared to one that does not include the first marking unit 64 containing the reflective material. In the light marking tool 60, the second marking unit 66 is provided adjacent to the first marking unit 64. Since the second marking unit 66 contains a light-emitting material (fluorescent material or phosphorescent material), the second marking unit 66 emits light by receiving light even without power supply. In the light marking tool 60, when light is emitted, the first marking unit 64 reflects light, and the second marking unit 66 emits light. Therefore, for example, an area of a part that receives light and shines is larger compared to one that includes only one of the first marking unit 64 and the second marking unit 66. As described above, in the light marking tool 60, the area of the part that receives light and shines is increased, so that the visibility at night is excellent. As described above, the light marking tool 60 does not require power supply and has excellent visibility at night.

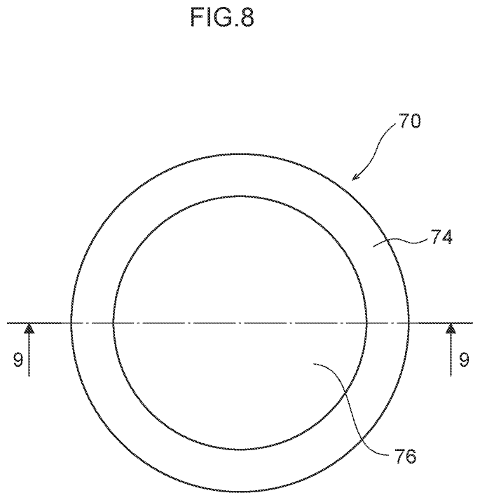

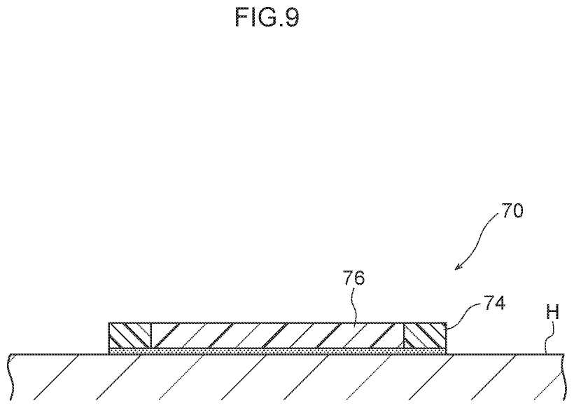

In the light marking tool 60 of the above-described embodiment, the second marking unit 66 surrounds the first marking unit 64, but the disclosure is not limited to this configuration. For example, like a vehicle-light marking tool 70 (hereinafter referred to as a “light marking tool 70” if appropriate) illustrated in FIGS. 8 and 9, a first marking unit 74 may surround a second marking unit 76. The first marking unit 74 is made of the same material as the first marking unit 28. The second marking unit 76 is made of the same material as the second marking unit 30.

In the light marking tool 60 of the above-described embodiment, the attachment part 62 is an adhesive layer, but the disclosure is not limited to this configuration as long as the base member 61 of the light marking tool 60 is attached to the vehicle door 50. For example, the attachment part 62 may be a screw hole for screwing.

Although one embodiment of the disclosure has been described above, the disclosure is not limited to the above, and it is a matter of course that various modifications other than the above can be made without departing from the gist of the disclosure.

With regard to the above embodiments, the following supplementary notes are further disclosed.

(Supplementary Note 1)

A vehicle-light marking tool including:
an attachment part that is attached to a vehicle-constituting member;
a first marking unit that is provided on a side of the attachment part opposite from an attachment side, the first marking unit containing a reflective material; and
a second marking unit that is provided adjacent to the first marking unit and contains a light-emitting material.

The vehicle-light marking tool of supplementary note 1 is attached to the vehicle-constituting member by attaching the attachment part to the vehicle-constituting member.

In the vehicle-light marking tool, the first marking unit containing the reflective material is provided on the side of the attachment part opposite from the attachment side. The first marking unit reflects light (incident light), so that the vehicle-light marking tool can be visually recognized even from a long distance at night. That is, the vehicle-light marking tool is excellent in visibility at night, for example, compared to one that does not include the first marking unit containing the reflective material.

The vehicle-light marking tool includes a second marking unit adjacent to the first marking unit. Since the second marking unit contains the light-emitting material, the second marking unit emits light by receiving light even without power supply.

In the vehicle-light marking tool, when light is emitted, the first marking unit reflects light, and the second marking unit emits light. Therefore, for example, the area of the part that receives light and shines is larger compared to one that includes only one of the first marking unit or the second marking unit. As described above, in the vehicle-light marking tool, since the area of the part that receives light and shines is increased, visibility at night is excellent.

From the above, the vehicle-light marking tool of supplementary note 1 does not require power supply and has excellent visibility at night.

(Supplementary Note 2)

The vehicle-light marking tool according to supplementary note 1, in which the second marking unit is made of a resin material containing the light-emitting material.

In the vehicle-light marking tool of supplementary note 2, since the second marking unit is formed of the resin material containing the light-emitting material, the second marking unit can be easily formed by resin molding (for example, a conventionally known resin molding method).

(Supplementary Note 3)

The vehicle-light marking tool according to supplementary note 1 or 2, in which the light-emitting material is a fluorescent material or a phosphorescent material.

In the vehicle-light marking tool of supplementary note 3, since the second marking unit contains the fluorescent material or the phosphorescent material, the second marking unit emits light by receiving light even without power supply.

(Supplementary Note 4)

The vehicle-light marking tool according to any one of supplementary notes 1 to 3, in which the reflective material is a retroreflective material.

In the vehicle-light marking tool of supplementary note 4, the first marking unit contains the retroreflective material, that is, the first marking unit has retroreflectivity. As described above, in the vehicle-light marking tool, the light incident on the first marking unit directly returns to the light source, so that the first marking unit (that is, the vehicle-light marking tool) can be easily visually recognized even from a long distance at night.

(Supplementary Note 5)

A vehicle-light marking tool including:
an attachment part attached to a vehicle-constituting member;
a first marking unit that is provided on a side of the attachment part opposite from an attachment side and that specularly reflects or retroreflects incident light; and
a second marking unit that is provided adjacent to the first marking unit and emits light using the incident light or diffusely reflects the incident light.

The vehicle-light marking tool of supplementary note 5 is attached to the vehicle-constituting member by attaching the attachment part to the vehicle-constituting member.

In the vehicle-light marking tool, the first marking unit that specularly reflects or retroreflects incident light (incident light) is provided on a side of the attachment part opposite from the attachment side. Therefore, the first marking unit (the vehicle-light marking tool) can be visually recognized even from a long distance at night. That is, the vehicle-light marking tool is excellent in visibility at night compared to, for example, one that does not include the first marking unit that specularly reflects or retroreflects incident light.

The vehicle-light marking tool includes a second marking unit adjacent to the first marking unit. The second marking unit emits light using the incident light or diffusely reflects the incident light even without power supply.

In the vehicle-light marking tool, when light is emitted, the first marking unit reflects light, and the second marking unit reflects or emits light. Therefore, for example, the area of the part that receives light and shines is larger compared to one that includes only one of the first marking unit or the second marking unit. As described above, in the vehicle-light marking tool, since the area of the part that receives light and shines is increased, visibility at night is excellent.

From the above, the vehicle-light marking tool of supplementary note 5 does not require power supply and has excellent visibility at night.

(Supplementary Note 6)

The vehicle-light marking tool according to any one of supplementary notes 1 to 5, in which the second marking unit is annular and surrounds the first marking unit. The “annular shape” here includes an annular shape having a circular outer shape, an elliptical annular shape having an elliptical outer shape, and a polygonal annular shape having a polygonal outer shape (for example, a triangle or a rectangle).

In the vehicle-light marking tool of supplementary note 6, since the annular second marking unit surrounds the first marking unit, the outer shape of the second marking unit becomes large. As a result, in the vehicle-light marking tool, for example, the area of the part that receives light and shines is larger compared to one in which the second marking unit is adjacent to the first marking unit without surrounding the first marking unit, and thus visibility at night is excellent.

(Supplementary Note 7)

The vehicle-light marking tool according to any one of supplementary notes 1 to 6, further including a base member including a closing part that is inserted into a through-hole formed in the vehicle-constituting member and closes the through-hole, a flange part that is formed integrally with the closing part and covers a peripheral part of the through-hole of the vehicle-constituting member, and a locking part as the attachment part that is formed integrally with the closing part and is inserted into the through-hole and locked, in which:
the first marking unit is provided at a position corresponding to the closing part on a front surface side of the base member, and
the flange part is provided with the second marking unit.

In the vehicle-light marking tool of supplementary note 7, the through-hole formed in the vehicle-constituting member is closed by the closing part of the base member, and the peripheral part of the through-hole of the vehicle-constituting member is covered by the flange part, so that an appearance of the vehicle-constituting member around the through-hole is improved. In the vehicle-light marking tool, the base member can be attached to the vehicle-constituting member by a simple operation of inserting and locking the locking part as the attachment part into the through-hole of the vehicle-constituting member. In the vehicle-light marking tool, the first marking unit is provided at a position corresponding to the closing part on the surface side of the base member, and the second marking unit is provided at the flange part adjacent to the first marking unit. Therefore, the area of the part that receives light and shines is increased, and the visibility at night is improved.

(Supplementary Note 8)

A vehicle-light marking tool including:
a base member including a closing part that is inserted into a through-hole formed in a vehicle-constituting member and closes the through-hole, a flange part that is formed integrally with the closing part and covers a peripheral part of the through-hole of the vehicle-constituting member, and a locking part as an attachment part that is formed integrally with the closing part and inserted into the through-hole and locked;
a first marking unit that is provided at a position corresponding to the closing part on a front surface side of the base member and reflects incident light; and
a second marking unit that is provided at the flange part and emits light using the incident light or reflects the incident light.

In the vehicle-light marking tool of supplementary note 8, the through-hole formed in the vehicle-constituting member is closed by the closing part of the base member, and the peripheral part of the through-hole of the vehicle-constituting member is covered by the flange part, so that the appearance of the vehicle-constituting member around the through-hole is improved. In the vehicle-light marking tool, the base member can be attached to the vehicle-constituting member by a simple operation of inserting and locking the locking part into the through-hole of the vehicle-constituting member.

In the vehicle-light marking tool, the first marking unit is provided at the position corresponding to the closing part on the surface side of the base member. Therefore, the first marking unit (the vehicle-light marking tool) can be visually recognized even from a long distance at night. That is, the vehicle-light marking tool is excellent in visibility at night compared to, for example, one that does not include a first marking unit that reflects incident light.

In the vehicle-light marking tool, the second marking unit is provided at the flange part adjacent to the first marking unit. The second marking unit emits light using the incident light or reflects the incident light even without power supply. In the vehicle-light marking tool, when light is emitted, the first marking unit reflects light, and the second marking unit emits or reflects light. Therefore, for example, the area of the part that receives light and shines is larger compared to one that includes only one of the first marking unit or the second marking unit. As described above, in the vehicle-light marking tool, since the area of the part that receives light and shines is increased, visibility at night is excellent.

From the above, the vehicle-light marking tool of supplementary note 8 does not require power supply and has excellent visibility at night.

(Supplementary Note 9)

The vehicle-light marking tool according to supplementary note 5 or 7, in which the first marking unit contains a retroreflective material.

In the vehicle-light marking tool of supplementary note 9, the first marking unit contains the retroreflective material, that is, the first marking unit has retroreflectivity. As described above, in the vehicle-light marking tool, the light incident on the first marking unit directly returns to the light source, so that the first marking unit (that is, the vehicle-light marking tool) can be easily visually recognized even from a long distance at night.

(Supplementary Note 10)

The vehicle-light marking tool according to any one of supplementary note 5, 7, or 9, in which the second marking unit contains a light-emitting material.

In the vehicle-light marking tool of supplementary note 10, since the second marking unit contains the light-emitting material, the second marking unit emits light by receiving light even without power supply. Therefore, in the vehicle-light marking tool, visibility at night is improved.

(Supplementary Note 11)

The vehicle-light marking tool according to any one of supplementary note 5, 7, or 9, in which the second marking unit contains a reflective material.

In the vehicle-light marking tool of supplementary note 11, since the first marking unit contains the reflective material, light incident on the first marking unit is reflected. Therefore, in the vehicle-light marking tool, visibility at night is improved.

(Supplementary Note 12)

The vehicle-light marking tool according to supplementary note 7 or 8, in which the second marking unit is attachable to and detachable from the base member.

In the vehicle-light marking tool of supplementary note 12, the first marking unit is attachable to and detachable from the base member. Therefore, in the vehicle-light marking tool, the first marking unit can be replaced.

(Supplementary Note 13)

The vehicle-light marking tool according to supplementary note 12, in which:
a recess is provided at a position corresponding to the closing part on a front surface side of the base member, and
the second marking unit is fitted into the recess.

In the vehicle-light marking tool of supplementary note 13, the first marking unit is fitted into the recess provided at the position corresponding to the closing part on the front surface side of the base member. Therefore, in the vehicle-light marking tool, for example, the step between the first marking unit and the flange part (second marking unit) can be reduced compared to one in which the first marking unit is installed on the surface of the base member in which the recess is not provided. This improves the appearance of the vehicle-light marking tool.

(Supplementary Note 14)

The vehicle-light marking tool according to any one of supplementary notes 1 to 13, in which the vehicle-constituting member is a vehicle door.

In the vehicle-light marking tool of supplementary note 14, the vehicle-light marking tool is a vehicle door. Therefore, by attaching the vehicle-light marking tool having excellent visibility at night to the vehicle door, the open state of the vehicle door at night can be easily visually recognized from the following vehicle.

The disclosure of Japanese Patent Application No. 2020-215841 filed on Dec. 24, 2020 is incorporated herein by reference in their entirety.

All documents, patent applications, and technical standards described in this specification are incorporated herein by reference to the same extent as if each document, patent application, and technical standard were specifically and individually indicated to be incorporated by reference.

1. A vehicle-light marking tool comprising:
an attachment part that is attached to a vehicle-constituting member;
a first marking unit that is provided on a side of the attachment part opposite from an attachment side, the first marking unit containing a reflective material; and
a second marking unit that is provided adjacent to the first marking unit and contains a light-emitting material.

2. The vehicle-light marking tool according to claim 1, wherein the second marking unit is made of a resin material containing the light-emitting material.

3. The vehicle-light marking tool according to claim 1, wherein the light-emitting material is a fluorescent material or a phosphorescent material.

4. The vehicle-light marking tool according to claim 1, wherein the reflective material is a retroreflective material.

5. A vehicle-light marking tool comprising:
an attachment part attached to a vehicle-constituting member;
a first marking unit that is provided on a side of the attachment part opposite from an attachment side and that specularly reflects or retroreflects incident light; and
a second marking unit that is provided adjacent to the first marking unit and emits light using the incident light or diffusely reflects the incident light.

6. The vehicle-light marking tool according to claim 1, wherein the second marking unit is annular and surrounds the first marking unit.

7. The vehicle-light marking tool according to claim 1, further comprising:
a base member including a closing part that is inserted into a through-hole formed in the vehicle-constituting member and closes the through-hole, a flange part that is formed integrally with the closing part and covers a peripheral part of the through-hole of the vehicle-constituting member, and a locking part as the attachment part that is formed integrally with the closing part and is inserted into the through-hole and locked, wherein:
the first marking unit is provided at a position corresponding to the closing part on a front surface side of the base member, and
the flange part is provided with the second marking unit.

8. A vehicle-light marking tool comprising:
a base member including a closing part that is inserted into a through-hole formed in a vehicle-constituting member and closes the through-hole, a flange part that is formed integrally with the closing part and covers a peripheral part of the through-hole of the vehicle-constituting member, and a locking part as an attachment part that is formed integrally with the closing part and inserted into the through-hole and locked;
a first marking unit that is provided at a position corresponding to the closing part on a front surface side of the base member and reflects incident light; and
a second marking unit that is provided at the flange part and emits light using the incident light or reflects the incident light.

9. The vehicle-light marking tool according to claim 5, wherein the first marking unit contains a retroreflective material.

10. The vehicle-light marking tool according to claim 5, wherein the second marking unit contains a light-emitting material.

11. The vehicle-light marking tool according to claim 5, wherein the second marking unit contains a reflective material.

12. The vehicle-light marking tool according to claim 7, wherein the second marking unit is attachable to and detachable from the base member.

13. The vehicle-light marking tool according to claim 12, wherein:
a recess is provided at a position corresponding to the closing part on a front surface side of the base member, and
the second marking unit is fitted into the recess.

14. The vehicle-light marking tool according to claim 1, wherein the vehicle-constituting member is a vehicle door.

15. The vehicle-light marking tool according to claim 5, wherein the second marking unit is annular and surrounds the first marking unit.

16. The vehicle-light marking tool according to claim 5, further comprising:
a base member including a closing part that is inserted into a through-hole formed in the vehicle-constituting member and closes the through-hole, a flange part that is formed integrally with the closing part and covers a peripheral part of the through-hole of the vehicle-constituting member, and a locking part as the attachment part that is formed integrally with the closing part and is inserted into the through-hole and locked, wherein:
the first marking unit is provided at a position corresponding to the closing part on a front surface side of the base member, and
the flange part is provided with the second marking unit.

17. The vehicle-light marking tool according to claim 8, wherein the second marking unit is attachable to and detachable from the base member.

18. The vehicle-light marking tool according to claim 17, wherein:
a recess is provided at a position corresponding to the closing part on a front surface side of the base member, and
the second marking unit is fitted into the recess.

19. The vehicle-light marking tool according to claim 5, wherein the vehicle-constituting member is a vehicle door.

20. The vehicle-light marking tool according to claim 8, wherein the vehicle-constituting member is a vehicle door.
